(19) United States
(12) Patent Application Publication
(10) Pub. No.: US 2026/0273954 A1
(43) Pub. Date: Sep. 17, 2026

(54) THERMAL PRINTER AND PORTABLE TERMINAL

(71) Applicant: Seiko Instruments Inc., Chiba-shi (JP)

(72) Inventor: Tomohiro MURATA, Chiba-shi (JP)

(21) Appl. No.: 19/558,995

(22) Filed: Mar. 6, 2026

(30) Foreign Application Priority Data
Mar. 14, 2025 (JP) 2025-041200

(51) Int. Cl. B41J 2/345; B41J 2/335; B41J 2/355; B41J 3/36; B41J 11/04; B41J 29/02

(52) U.S. Cl. CPC B41J 2/345; B41J 2/33505; B41J 2/355; B41J 3/36; B41J 11/04; B41J 29/023; B41J 2202/31

(57) ABSTRACT

A thermal printer, includes a thermal head configured to perform printing on recording paper; a platen roller, which is arranged at a position opposed to the thermal head, and is configured to convey the recording paper by nipping the recording paper between the platen roller and the thermal head; a head support member having conductivity, which is configured to support the thermal head; a head shaft having conductivity, which is configured to rotatably support the head support member; a motor housing having conductivity, which is provided on an outer periphery of a motor main body configured to rotate the platen roller; and a conductive member configured to be held in contact with the head support member, the head shaft, and the motor housing to provide electrical connection therebetween.

### RELATED APPLICATIONS

This application claims priority to Japanese Patent application No. JP2025-041200, filed on Mar. 14, 2025, the entire content of which is incorporated herein by reference.

### BACKGROUND OF THE INVENTION

### 1. Field of the Invention

An embodiment of the present disclosure relates to a thermal printer and a portable terminal.

### 2. Description of the Related Art

Hitherto, a thermal printer has been known as a printer configured to perform printing on recording paper (heat-sensitive paper). As the thermal printer, some thermal printers are mounted on portable terminals (for example, card payment terminals). In the thermal printer, components such as a heat radiation plate of a thermal head or a platen roller, which form a printing mechanism, may be charged due to interference from external static electricity, friction of a printing medium, or the like. When those components are charged, secondary discharge may occur to the thermal head arranged in the vicinities of those components. When discharge occurs to the thermal head, the electricity flows into a control board of the terminal via a flexible substrate, resulting in a risk of occurrence of an electrical malfunction.

Some thermal printers have a configuration in which static electricity discharged from the outside is released to the ground. In Japanese Patent Application Laid-open No. 2020-066144, there is disclosed a thermal printer including: a thermal head that performs printing on recording paper; a platen roller that is arranged at a position opposed to the thermal head, and conveys the recording paper by nipping the recording paper between the platen roller and the thermal head; a head support plate having conductivity, to which the thermal head is to be fixed; a frame including a shaft support portion that supports the head support plate, and rotatably supports the platen roller about an axis; and an electroconductive member having conductivity and provided between a side surface of the shaft support portion and the head support plate.

In the thermal printer, the thermal head is located in the vicinity of a paper passing surface. Accordingly, when the heat radiation plate is made of metal such as a stainless steel (SUS) material, there is a high risk that the heat radiation plate is charged due to friction of paper, or the like. Meanwhile, the printing mechanism including the heat radiation plate is arranged in the vicinity of a delivery port, and as a result, users often touch or bring fingertips close to the printing mechanism. In such a case, when the heat radiation plate is not grounded by some method, after the heat radiation plate is charged due to friction of paper, or the like, discharge occurs, for example, at the time when the user tries to take out the paper, resulting in that there is a risk that malfunctions occur in electronic components such as the thermal head and a motor or the control board. For example, there is a configuration in which various electronic components such as the heat radiation plate and the motor, metal components, and the control board are connected by ground wires so as to be grounded. However, in this configuration, securing a space is required, and an increase in assembly work and an increase in the number of components become problems.

The present disclosure has been made in view of the above-mentioned problems, and has an object to suppress malfunctions due to static electricity, and suppress an increase in assembly work and an increase in the number of components, without requiring securing a space.

### SUMMARY OF THE INVENTION

According to one embodiment of the present invention, there is provided a thermal printer, including: a thermal head configured to perform printing on recording paper; a platen roller, which is arranged at a position opposed to the thermal head, and is configured to convey the recording paper by nipping the recording paper between the platen roller and the thermal head; a head support member having conductivity, which is configured to support the thermal head; a head shaft having conductivity, which is configured to rotatably support the head support member; a motor housing having conductivity, which is provided on an outer periphery of a motor main body configured to rotate the platen roller; and a conductive member configured to be held in contact with the head support member, the head shaft, and the motor housing to provide electrical connection therebetween.

In some embodiments, the thermal printer includes a conductive member that elastically maintains contact with the head support member, the head shaft, and the motor housing, and further contacts a ground portion on a control board, thereby suppressing electrostatic malfunction without additional wiring.

According to one embodiment of the present invention, there is provided a portable terminal, including the thermal printer of any one of the embodiments of the present invention.

In one embodiment, the portable terminal further includes a control board including a ground portion and a casing including: a bottom surface portion; and a delivery surface portion provided to stand upright from the bottom surface portion and having a delivery port through which the recording paper is allowed to be delivered to an outside, wherein the control board is provided so as to extend along the delivery surface portion, and wherein the ground portion is provided at an end portion of the control board on a side opposite to the bottom surface portion.

### BRIEF DESCRIPTION OF THE DRAWINGS

FIG. 1 is a perspective view of a portable terminal according to at least one embodiment of the present disclosure.

FIG. 2 is a sectional view of the portable terminal according to the at least one embodiment.

FIG. 3 is a perspective view of a thermal printer according to the at least one embodiment.

FIG. 4 is a side view for illustrating an assembled state of a conductive member with a control board in the at least one embodiment being removed.

FIG. 5 is a view of the assembled state of the conductive member with the control board in the at least one embodiment being removed, as viewed from a delivery surface side.

FIG. 6 is a view of a mounted state of the control board in the at least one embodiment, as viewed from the delivery surface side.

FIG. 7 is a sectional view taken along the line VII-VII of FIG. 6, for illustrating the assembled state of the conductive member in the mounted state of the control board.

FIG. 8 is a bottom view of the portable terminal according to the at least one embodiment.

FIG. 9 is a sectional view taken along the line IX-IX of FIG. 8, for illustrating the assembled state of the conductive member in the mounted state of the control board.

FIG. 10 is a perspective view of the conductive member in the at least one embodiment in an initial state.

FIG. 11 is a view of the initial state of the conductive member in the at least one embodiment together with the assembled state (broken lines), as viewed from the delivery surface side.

FIG. 12 is a side view for illustrating the initial state of the conductive member in the at least one embodiment together with the assembled state (broken lines).

FIG. 13 is a plan view for illustrating the initial state of the conductive member in the at least one embodiment together with the assembled state (broken lines).

### DETAILED DESCRIPTION OF THE PREFERRED EMBODIMENTS

Now, at least one embodiment of the present disclosure is described with reference to the drawings. In the at least one embodiment, a portable terminal that can be carried by a user is described as an example of a portable terminal including a thermal printer according to the present disclosure. In the drawings used for the following description, the scale reduction of each member is appropriately changed so that each member has a recognizable size.

In the at least one embodiment and modification examples thereof described below, corresponding components are denoted by the same reference symbols, and description thereof may be omitted. In addition, in the following description, expressions indicating relative or absolute arrangement, such as "parallel", "orthogonal", "center", and "coaxial", not only strictly represent such arrangement, but also represent a state of being relatively displaced by an angle or a distance such that a tolerance or the same function is obtained.

Although the conductive member is described in the present embodiment as a spring member, the conductive member may be any conductive structure capable of simultaneously contacting the head support member, the head shaft, and the motor housing.

As used herein, the term "elastic contact" refers to a contact state in which a restoring force of the conductive member maintains continuous electrical contact between components without the use of a fastening member.

### Portable Terminal

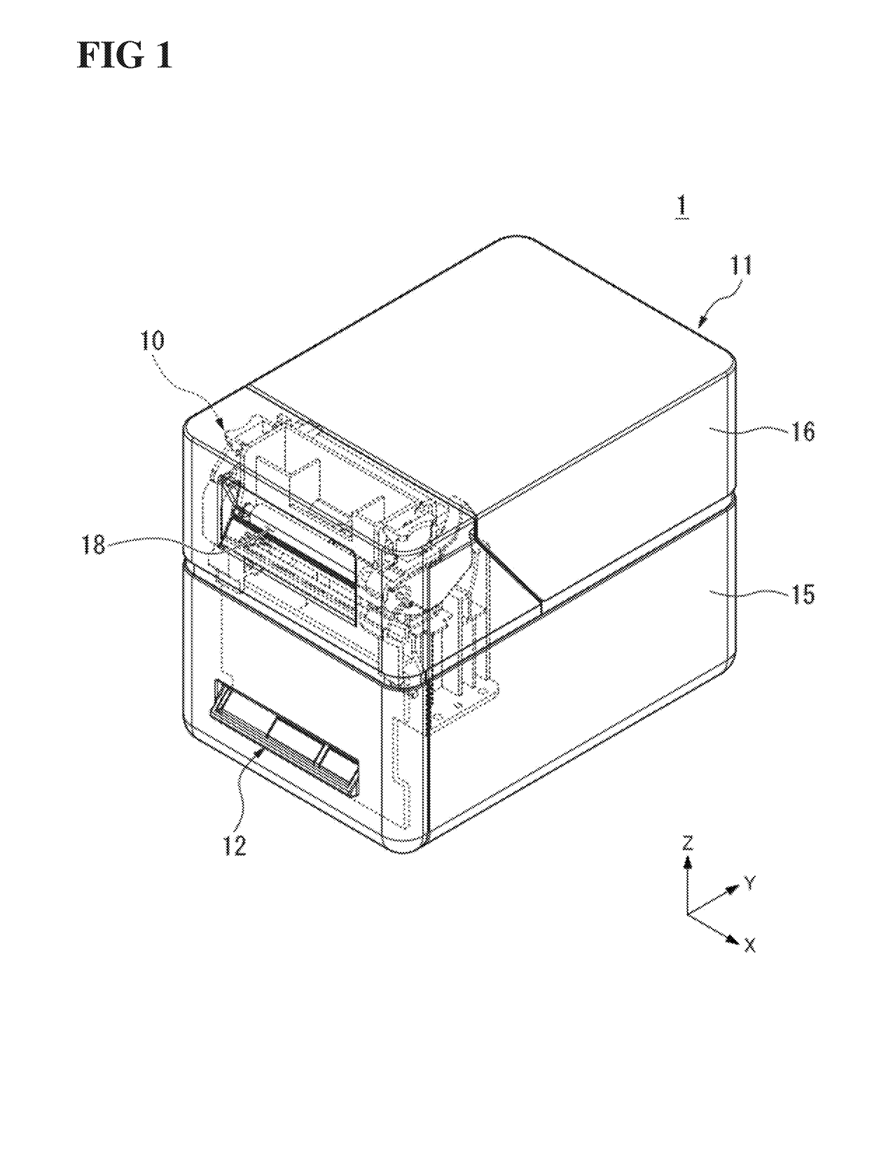

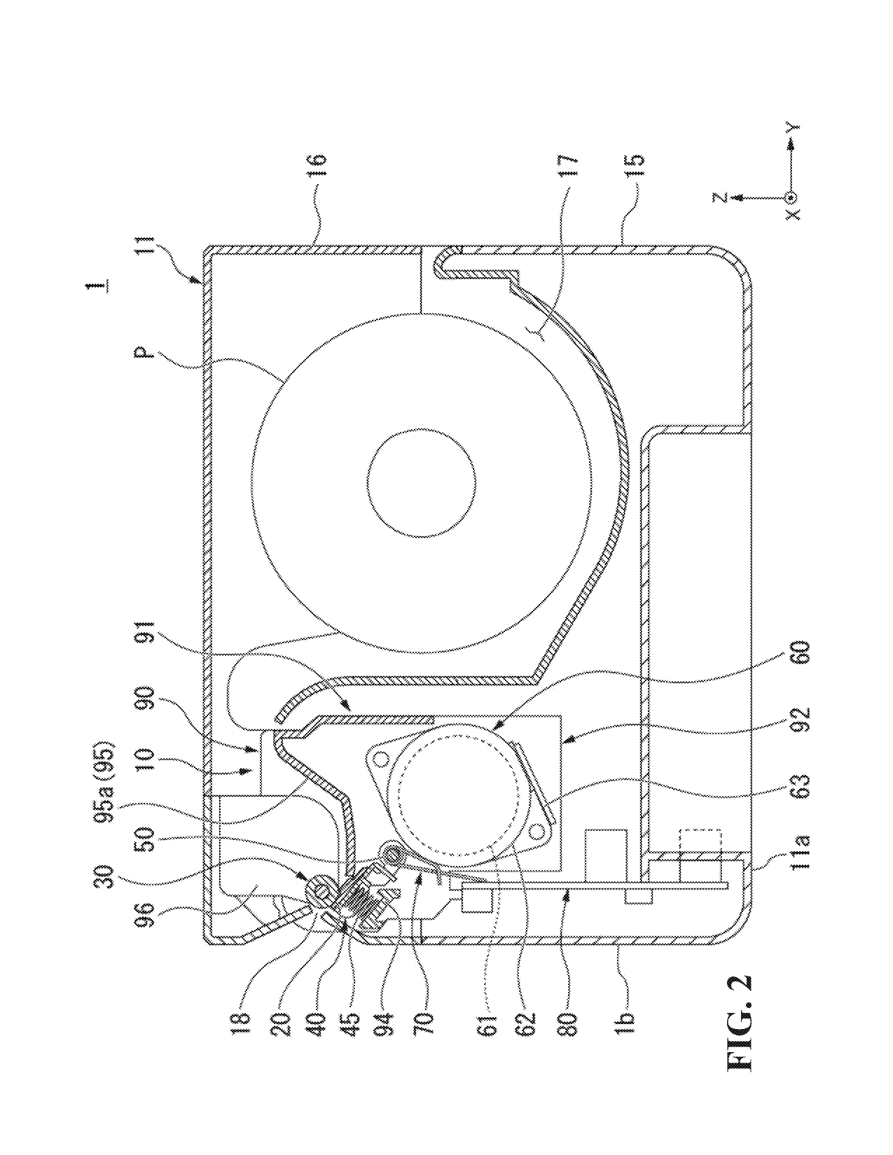

FIG. 1 is a perspective view of a portable terminal 1 according to the at least one embodiment. FIG. 2 is a sectional view of the portable terminal 1 according to the at least one embodiment.

Referring to FIGS. 1 and 2 together, the portable terminal 1 is formed in a rectangular parallelepiped shape. The portable terminal 1 includes a thermal printer 10, a casing 11, and an operation unit 12. In the following description, an X, Y, Z orthogonal coordinate system is used as required. The X direction corresponds to a width direction of the portable terminal 1. The Y direction corresponds to a depth direction (front-rear direction) of the portable terminal 1. The Z direction corresponds to a height direction (vertical direction) of the portable terminal 1. In each of the X direction, the Y direction, and the Z direction, a direction indicated by the arrow in each drawing is a plus (+) direction, and a direction opposite to the direction indicated by the arrow is a minus (-) direction.

The casing 11 is formed in a rectangular parallelepiped box shape that is elongated in the Y direction. The casing 11 includes a casing main body 15 and a printer cover 16.

In the casing main body 15, there is formed a recording paper receiving portion 17 configured to receive recording paper P (heat-sensitive paper). The recording paper receiving portion 17 is formed on the +Y side of the casing main body 15. The recording paper P is received in the recording paper receiving portion 17 under a state of being wound into a roll.

The printer cover 16 is turnably connected to the casing main body 15 through intermediation of a hinge portion (not shown). The printer cover 16 is configured to open and close the recording paper receiving portion 17. On the -Y surface side of the casing 11, there is formed a delivery port 18 through which the recording paper P is allowed to be delivered to an outside.

The operation unit 12 is arranged on the same surface side (-Y surface side) as the surface side on which the delivery port 18 is formed, in the casing 11. The operation unit 12 is arranged below the delivery port 18. The operation unit 12 includes, for example, a power button, and a paper feeding button, which can be operated by the user. For example, the operation unit 12 may be a touch panel. The operation unit 12 may function as an input display unit. The operation unit 12 may display various pieces of information on a screen, and may be able to operate information displayed on the screen.

### Thermal Printer

The thermal printer 10 is mounted in the casing 11. The thermal printer 10 is arranged at a position adjacent to the delivery port 18. The thermal printer 10 is configured to print information on the recording paper P, which is fed from the recording paper receiving portion 17, and to deliver the recording paper P through the delivery port 18.

The thermal printer 10 includes a thermal head 20, a platen roller 30, a head support member 40, a head shaft 50, a motor 60, a conductive member 70, a control board 80, and a frame 90.

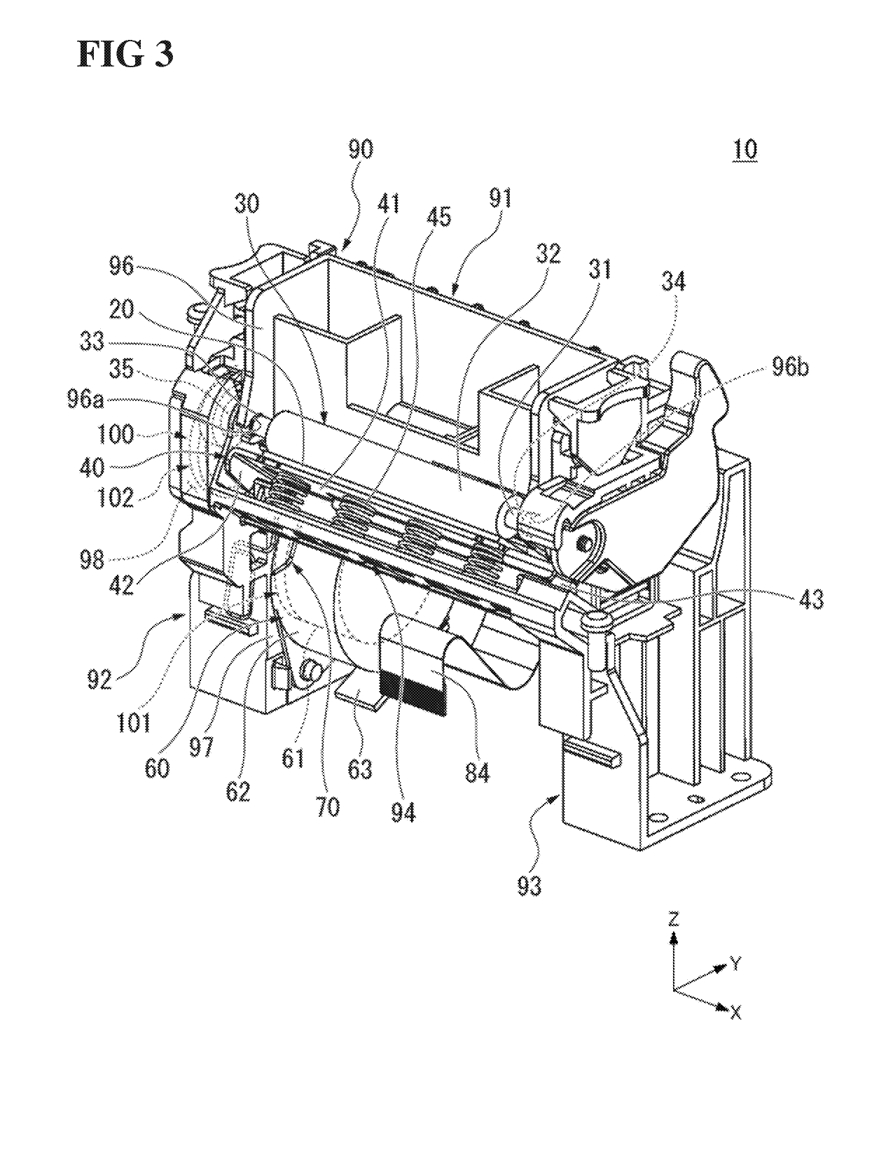

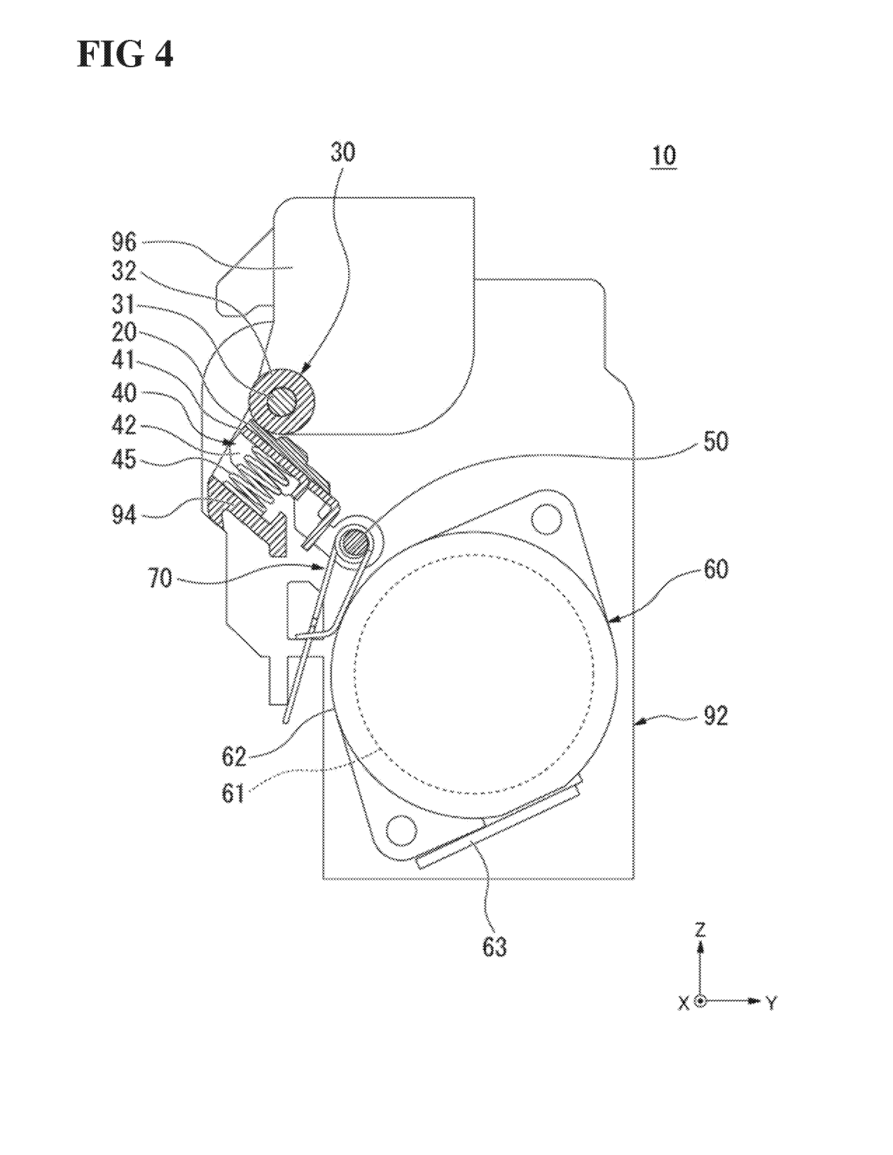

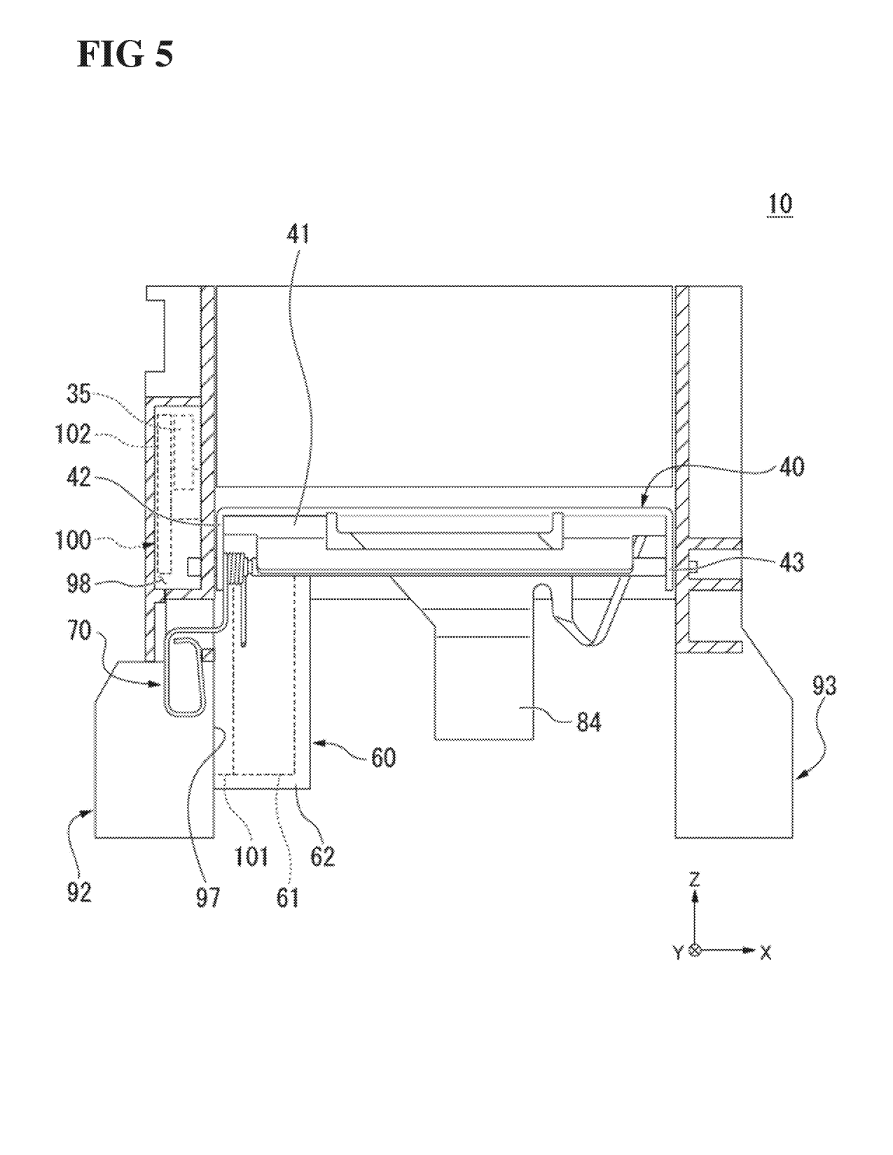

FIG. 3 is a perspective view of the thermal printer 10 according to the at least one embodiment. FIG. 4 is a side view for illustrating an assembled state of the conductive member 70 with the control board 80 in the at least one embodiment being removed. FIG. 5 is a view for illustrating the assembled state of the conductive member 70 with the control board 80 in the at least one embodiment being removed, as viewed from a delivery surface side. In FIGS. 3 to 5, illustration of the control board 80 is omitted.

Referring to FIGS. 2 to 5 together, components forming the thermal printer 10 are supported by the frame 90. The frame 90 is made of a material such as a polycarbonate resin containing glass fiber. The frame 90 is formed in a U-shape (inverted U-shape) opening downward as viewed from the Y direction.

The frame 90 includes: a base wall portion 91 extending in the X direction; a first side wall portion 92 connected to a first end (-X end) of the base wall portion 91 and extending in the -Z direction from the first end (-X end) of the base wall portion 91; a second side wall portion 93 connected to a second end (+X end) of the base wall portion 91 and extending in the -Z direction from the second end (+X end) of the base wall portion 91; and a front wall portion 94 arranged on the -Y side (front side) of the base wall portion 91, extending in the X direction, and connected to the first side wall portion 92 and the second side wall portion 93.

The base wall portion 91 includes a guide wall portion 95 including a paper passing surface 95a that guides the recording paper P, and an upper wall portion 96 located in the -Y direction and the +Z direction with respect to the guide wall portion 95. A gap through which the recording paper P is allowed to pass is defined between the paper passing surface 95a of the guide wall portion 95 and the upper wall portion 96. The paper passing surface 95a of the guide wall portion 95 is formed in a shape that curves toward the +Y direction and the -Z direction when viewed in YZ cross-section. At front lower edges of side plate portions on both end sides in the X direction of the upper wall portion 96, roller receiving grooves 96a and 96b in which shaft end portions of the platen roller 30 (end portions of a platen shaft 31) are to be received are formed.

A portion of the first side wall portion 92 that projects in the -Z direction with respect to the base wall portion 91 forms a motor support portion 97 that supports the motor 60. In a portion on the -X direction side of the first side wall portion 92, a transmission mechanism receiving portion 98 that receives a power transmission mechanism 100 is formed.

The platen roller 30 is arranged at a position opposed to the thermal head 20. The platen roller 30 conveys the recording paper P toward the delivery port 18 by nipping the recording paper P between the platen roller 30 and the thermal head 20. The platen roller 30 is supported by the frame 90 so as to be rotatable about an axis extending in the X direction and so as to be detachably mountable to the frame 90. The platen roller 30 includes a platen shaft 31 and a roller main body 32.

The platen shaft 31 extends in the X direction. At both end portions of the platen shaft 31 in the X direction, there are mounted a first bearing 33 and a second bearing 34, respectively. The bearings 33 and 34 are supported in the roller receiving grooves 96a and 96b, respectively. The bearings 33 and 34 are supported in the roller receiving grooves 96a and 96b by locking springs (not shown) supported by the frame 90.

In a portion of the platen shaft 31 located in the -X direction with respect to the first bearing 33, a driven gear 35 is provided. The driven gear 35 is located in the -X direction with respect to the side plate portion on the -X end side of the upper wall portion 96 under a state in which the platen roller 30 is supported in the roller receiving grooves 96a and 96b.

The roller main body 32 is made of, for example, rubber. The roller main body 32 is mounted on the platen shaft 31. The roller main body 32 is provided at a portion of the platen shaft 31 other than the both end portions of the platen shaft 31 in the X direction. The roller main body 32 is arranged on a center side in the X direction of the platen shaft 31. An outer peripheral surface of the roller main body 32 is held in contact with the thermal head 20.

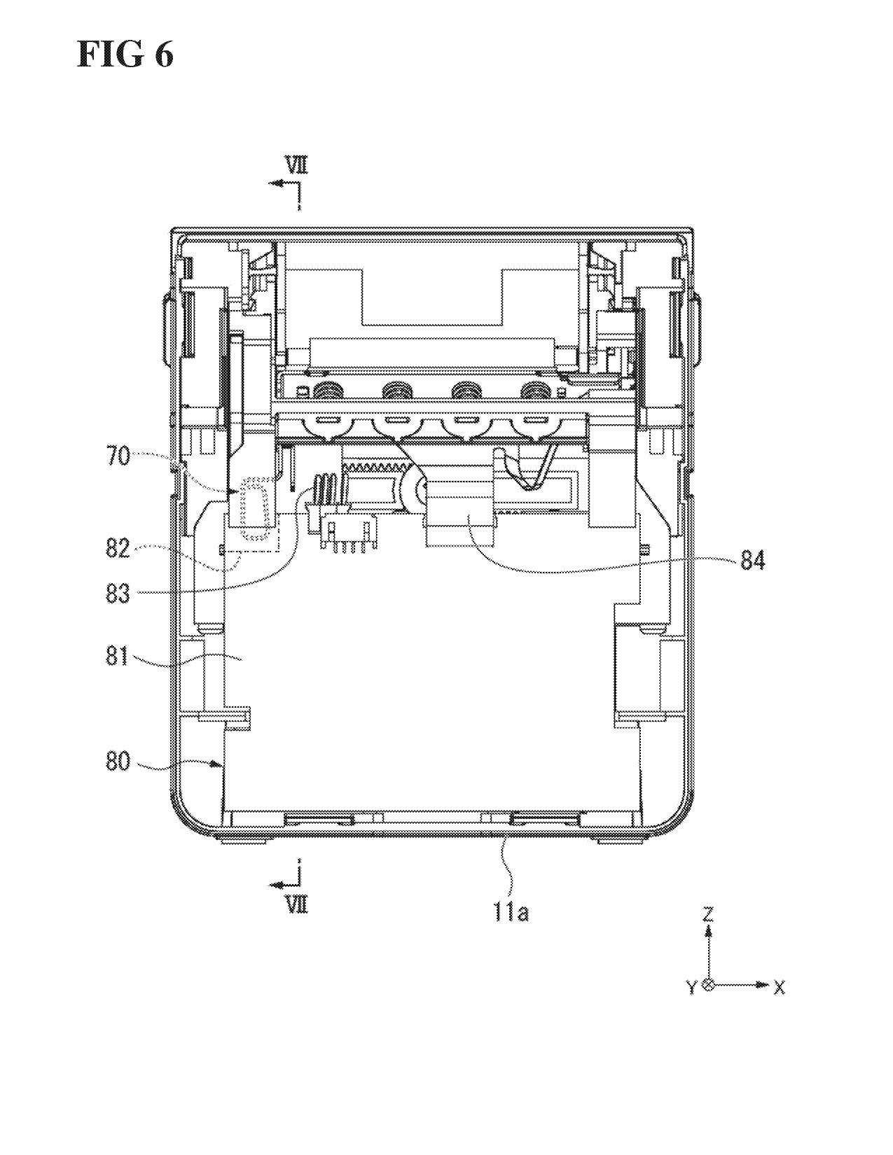

At a portion of the frame 90 which is located in the +X direction with respect to the motor support portion 97, a motor 60 is arranged. The motor 60 is arranged under a state in which an output shaft (not shown) thereof projects in the -X direction. The motor 60 is connected to the control board 80 via, for example, a terminal plate 63 and wiring 83 (see FIG. 6). The motor 60 is fixed to the frame 90. The motor 60 includes a motor main body 61 and a motor housing 62.

The motor main body 61 includes the output shaft (not shown). The motor main body 61 is a power source that rotates the platen roller 30. The motor housing 62 is provided on an outer periphery of the motor main body 61. The motor housing 62 is made of a material having conductivity. The motor housing 62 is made of, for example, metal.

Between the motor 60 and the platen roller 30, the power transmission mechanism 100 that transmits power of the motor 60 to the platen roller 30 is provided. The power transmission mechanism 100 is received in the transmission mechanism receiving portion 98 of the frame 90. The power transmission mechanism 100 includes a first speed reduction mechanism 101 that reduces power of the motor 60, and a second speed reduction mechanism 102 located between the first speed reduction mechanism 101 and the platen roller 30.

The first speed reduction mechanism 101 is arranged between the motor main body 61 and the motor support portion 97. For example, the first speed reduction mechanism 101 is a planetary gear mechanism. The first speed reduction mechanism 101 includes an output gear (not shown) projecting toward the -X direction. The second speed reduction mechanism 102 is a gear train mechanism including, for example, a two-stage gear. The second speed reduction mechanism 102 connects between the output gear of the first speed reduction mechanism 101 and the driven gear 35 of the platen roller 30.

The thermal head 20 is a component for performing printing on the recording paper P. The thermal head 20 is formed in a plate shape extending in the X direction. On a surface (head surface) of the thermal head 20 facing the platen roller 30, a plurality of heating elements (not shown) are arranged at intervals in the X direction.

The thermal head 20 is connected to the control board 80 via a flexible substrate 84. A driver integrated circuit (IC) (drive circuit) (not shown) that is driven based on a signal from the control board 80 is mounted on the thermal head 20. In the thermal head 20, the driver IC is driven based on the signal from the control board 80, thereby controlling heat generation of the heating elements. Then, at the time when the recording paper P passes through the heating elements, printing is performed on the recording paper P.

The head support member 40 is a component for supporting the thermal head 20. The head support member 40 also functions as a heat radiation member that radiates heat of the thermal head 20 (heat generation of the heating elements) to the outside. The head support member 40 is made of a material having conductivity. The head support member 40 is made of, for example, metal.

The head support member 40 includes: a head support plate 41 that supports the thermal head 20; and connection arms 42 and 43 connected to the head support plate 41 and rotatably supported on the head shaft 50.

The head support plate 41 is formed in a plate shape extending in the X direction. The thermal head 20 is fixed to the head support plate 41 by being affixed thereto. The connection arms 42 and 43 are respectively connected to both end portions in the X direction of the head support plate 41. The head support plate 41 and the connection arms 42 and 43 are integrally formed from, for example, the same metal member.

The head shaft 50 is a shaft member that rotatably supports the head support member 40. The head shaft 50 is made of a material having conductivity. The head shaft 50 is made of, for example, metal. The head shaft 50 extends in the X direction in parallel to the platen shaft 31.

Through holes through which the head shaft 50 is to be inserted are formed in the connection arms 42 and 43. Both end portions in the X direction of the head shaft 50 project outward in the X direction beyond the connection arms 42 and 43 through the through holes of the connection arms 42 and 43. Both end portions in the X direction of the head shaft 50 are fixed to the side plate portions of the frame 90.

Between the front wall portion 94 of the frame 90 and the head support plate 41, elastic members 45 are provided. A plurality of (four, in the at least one embodiment) elastic members 45 are provided at intervals in the X direction. On a surface of the front wall portion 94 facing the head support plate 41, recessed portions (not shown) for receiving the elastic members 45 may be formed. For example, the same number of recessed portions (four recessed portions, in the at least one embodiment) as the number of the elastic members 45 are formed.

The elastic members 45 urge the front wall portion 94 of the frame 90 and the head support plate 41 in a direction of separating the front wall portion 94 and the head support plate 41 from each other. The elastic members 45 are configured to constantly press the head support plate 41 toward the platen roller 30. The elastic members 45 are, for example, coil springs. Front end portions of the elastic members 45 are inserted into the recessed portions (not shown) of the front wall portion 94. Rear end portions of the elastic members 45 are held in abutment against a front surface of the head support plate 41.

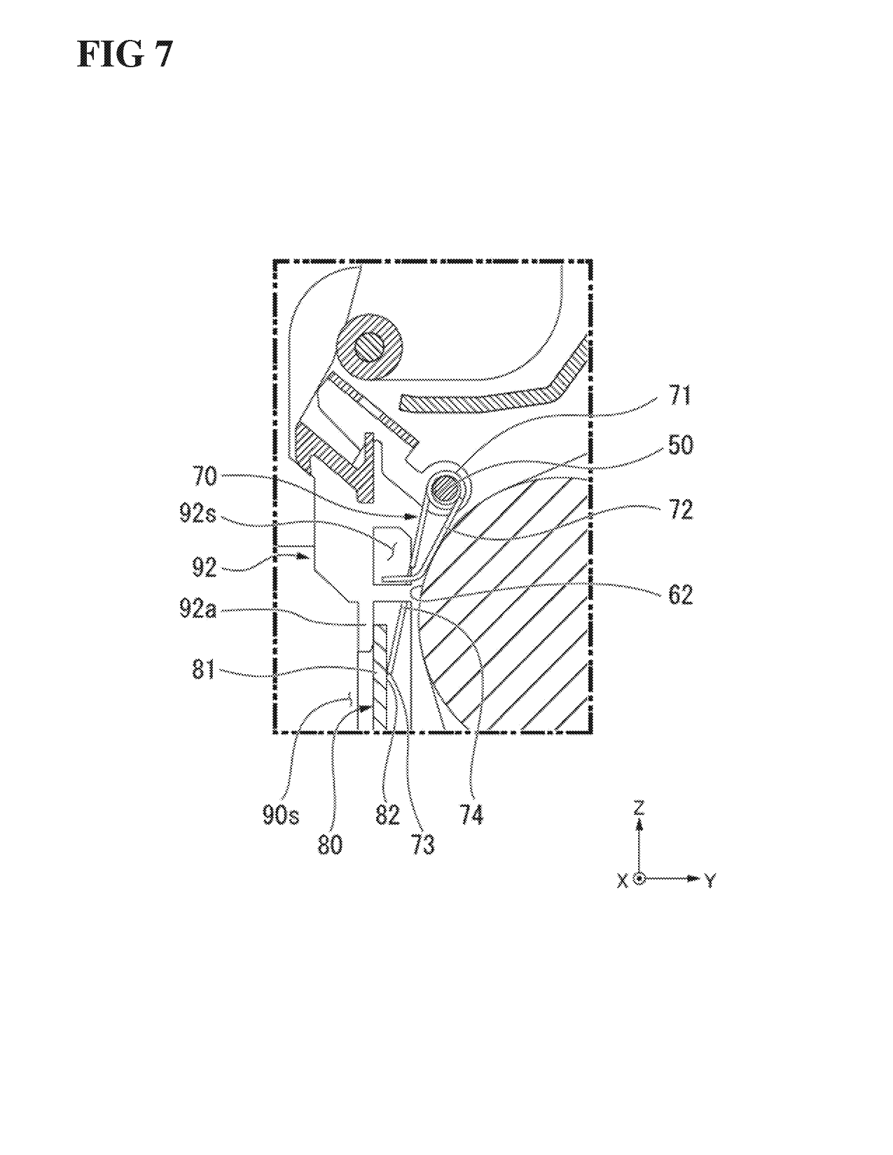

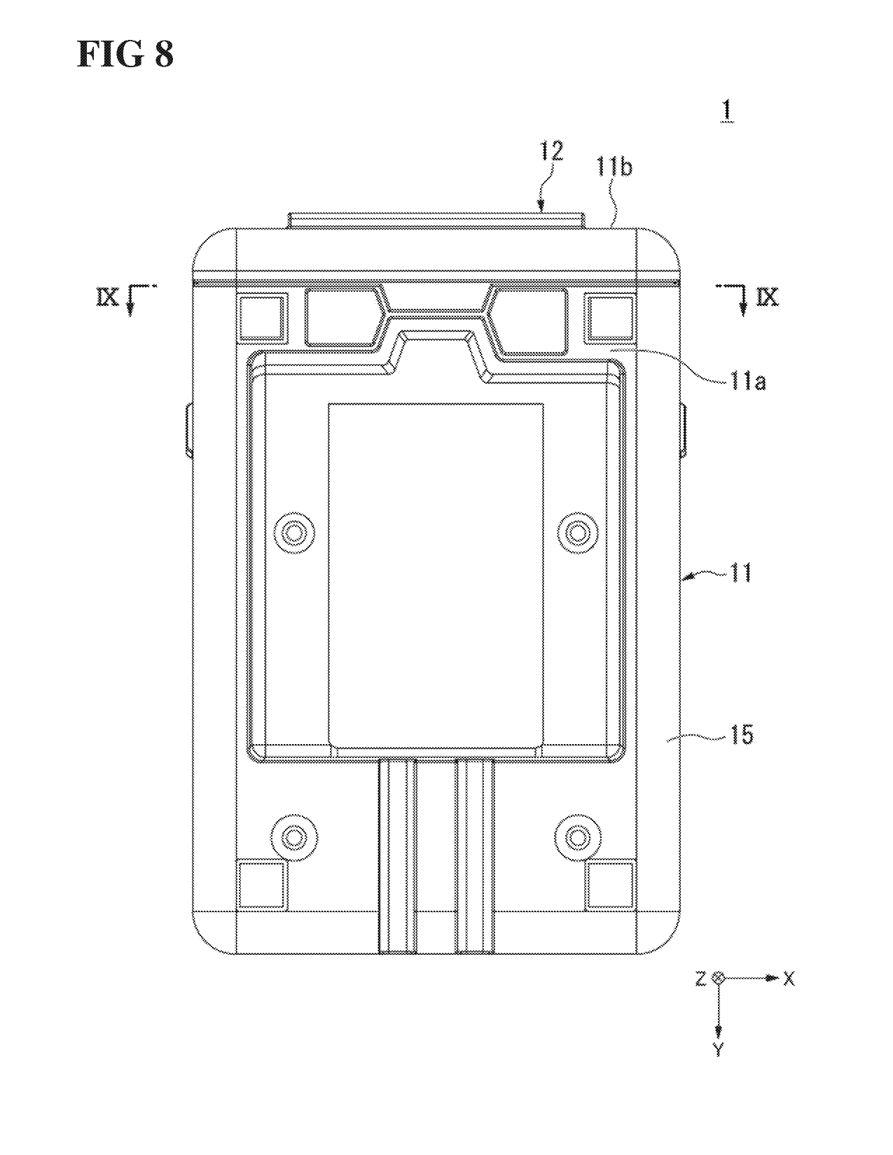

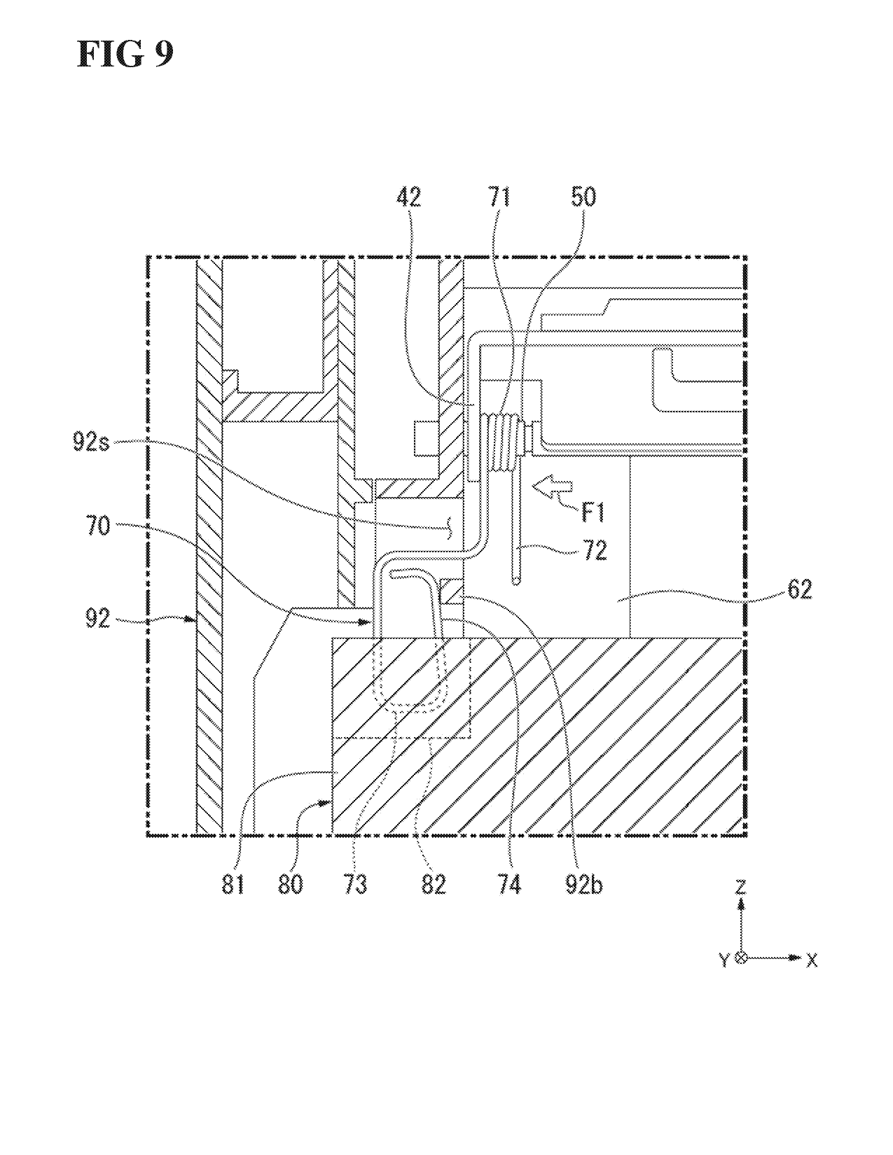

FIG. 6 is a view of a mounted state of the control board 80 in the at least one embodiment, as viewed from the delivery surface side. FIG. 7 is a sectional view taken along the line VII-VII of FIG. 6, for illustrating the assembled state of the conductive member 70 in the mounted state of the control board 80. FIG. 8 is a bottom view of the portable terminal 1 according to the at least one embodiment. FIG. 9 is a sectional view taken along the line IX-IX of FIG. 8, for illustrating the assembled state of the conductive member 70 in the mounted state of the control board 80.

Referring to FIGS. 2 and 6 to 8 together, the casing 11 includes: a bottom surface portion 11a; and a delivery surface portion 11b, which is provided to stand upright from the bottom surface portion 11a, and has the delivery port 18 through which the recording paper P is allowed to be delivered to the outside. The control board 80 is provided so as to extend along the delivery surface portion 11b.

The control board 80 includes a board main body 81 and a ground portion 82. The board main body 81 is formed in a rectangular plate shape. The ground portion 82 is a conductive region of the control board electrically connected to a ground potential of the portable terminal. The ground portion 82 is provided at an end portion of the control board 80 on a side opposite to the bottom surface portion 11a. The ground portion 82 is provided at an end portion on the -X side and the +Z side in a rear surface (+Y side surface) of the board main body 81.

The conductive member 70 is made of a material having conductivity. The conductive member 70 is made of, for example, metal. The conductive member 70 is formed of, for example, a member having a restoring force. In the at least one embodiment, the conductive member 70 is formed of a torsion coil spring made of metal. The conductive member 70 may be formed of a leaf spring. The formation mode of the conductive member 70 is not limited to the foregoing, and can be changed according to design specifications.

Referring to FIGS. 3 to 5 together, under the state in which the control board 80 is removed, the conductive member 70 is held in contact with the head support member 40, the head shaft 50, and the motor housing 62 to provide electrical connection therebetween. The conductive member 70 is held in elastic contact with the head support member 40, the head shaft 50, and the motor housing 62.

Referring to FIGS. 6, 7, and 9, together, in the mounted state of the control board 80, the conductive member 70 is held in contact with the head support member 40, the head shaft 50, the motor housing 62, and the ground portion 82 to provide electrical connection therebetween. In the mounted state of the control board 80, the conductive member 70 is held in elastic contact with the head support member 40, the head shaft 50, the motor housing 62, and the ground portion 82.

The frame 90 includes a locking portion 92a that locks the control board 80 in the mounted state of the control board 80. The locking portion 92a is provided on the first side wall portion 92. On a lower front side of the frame 90, a space 90s having a size that allows the control board 80 to pass through the space 90s at the time of mounting the control board 80 is formed. The locking portion 92a projects downward from a surface of the first side wall portion 92 facing the space 90s. The locking portion 92a is formed in a plate shape extending in the Z direction. A rear surface of the locking portion 92a is held in contact with a front surface (surface opposite to the surface on which the ground portion 82 is formed) of the control board 80 in the mounted state of the control board 80.

The frame 90 includes a stopper 92b configured to be able to be in contact with a part of the conductive member 70. The stopper 92b is provided on the first side wall portion 92. In the first side wall portion 92, a space 92s having a size that allows the conductive member 70 to pass through the space 92s at the time of assembling the conductive member 70 is formed. The stopper 92b extends in the front-rear direction below the space 92s. A portion on the -X direction side of the stopper 92b is held in contact with a part of the conductive member 70 in the assembled state of the conductive member 70.

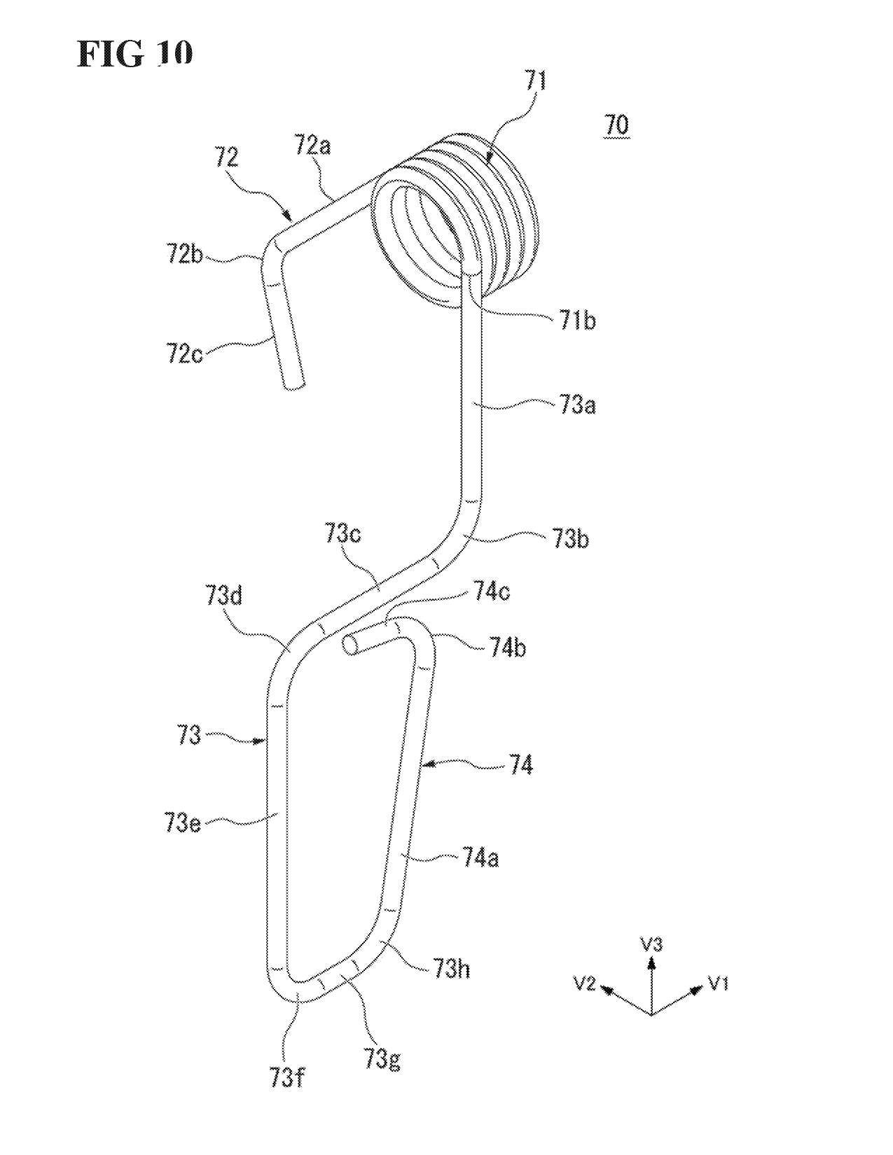

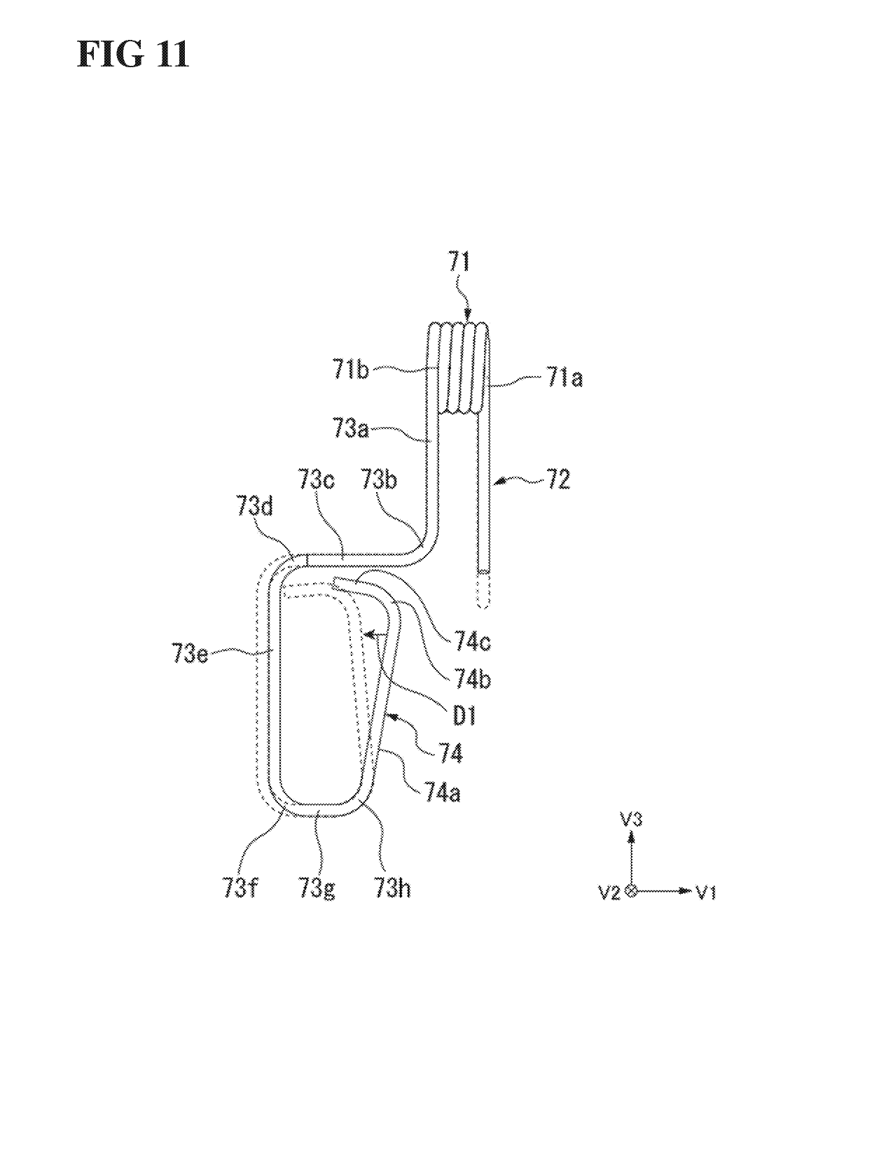

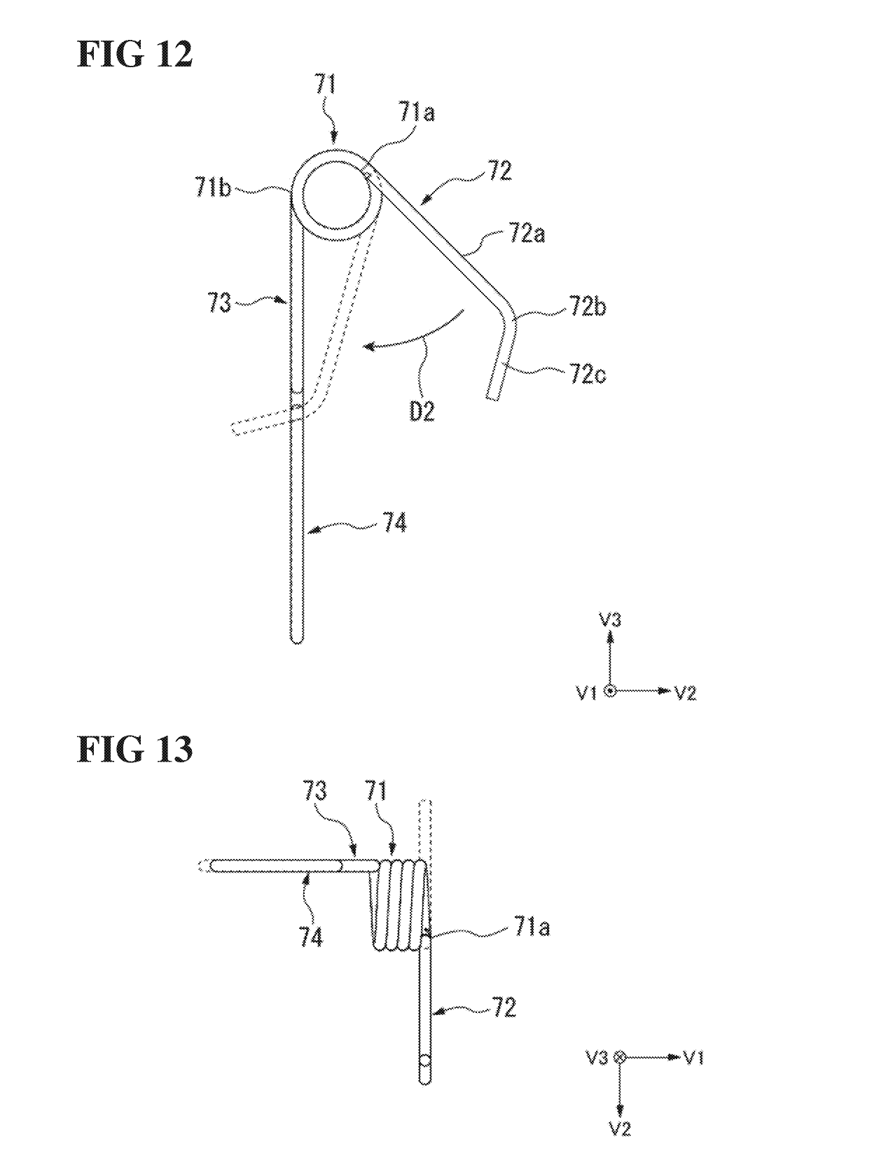

FIG. 10 is a perspective view of the conductive member 70 in the at least one embodiment in an initial state. FIG. 11 is a view of the initial state of the conductive member 70 in the at least one embodiment together with the assembled state (broken lines), as viewed from the delivery surface side. FIG. 12 is a side view for illustrating the initial state of the conductive member 70 in the at least one embodiment together with the assembled state (broken lines). FIG. 13 is a plan view for illustrating the initial state of the conductive member 70 in the at least one embodiment together with the assembled state (broken lines). In FIGS. 11 to 13, solid lines represent the initial state of the conductive member 70, and broken lines represent the assembled state of the conductive member 70. The initial state means a free length (free) state before the conductive member 70 is assembled. The assembled state means a loaded length (compressed) state after the conductive member 70 is assembled.

Referring to FIGS. 10 to 13 together, the conductive member 70 includes a winding portion 71, a housing-side extending portion 72, a ground-side extending portion 73, and a stopper-side extending portion 74. The winding portion 71, the housing-side extending portion 72, the ground-side extending portion 73, and the stopper-side extending portion 74 are integrally formed from the same member.

In the following description, a V1, V2, V3 orthogonal coordinate system is used as required. The V1 direction corresponds to an opening direction of the winding portion 71. The V2 direction corresponds to a direction orthogonal to the V1 direction (depth direction of the drawing sheet of FIG. 11). The V3 direction corresponds to a direction orthogonal to each of the V1 direction and the V2 direction (vertical direction of the drawing sheet of FIG. 11). In each of the V1 direction, the V2 direction, and the V3 direction, the direction indicated by the arrow in each drawing is a plus (+) direction, and a direction opposite to the direction indicated by the arrow is a minus (-) direction.

The winding portion 71 is a portion of the conductive member 70 that is wound around the head shaft 50 to be pressed against the connection arm 42 and the head shaft 50. The winding portion 71 is formed in a coil shape opening in the V1 direction. The winding portion 71 includes a first end portion 71a located on the +V1 end side, and a second end portion 71b located on a side opposite to the first end portion 71a in the V1 direction (-V1 end side).

In the assembled state of the conductive member 70, the opening direction (V1 direction) of the winding portion 71 follows the direction in which the head shaft 50 extends (X direction). In the assembled state of the conductive member 70, the second end portion 71b (-X end portion) of the winding portion 71 is held in contact with the +X side surface of the connection arm 42 on the first side wall portion 92 side (see FIGS. 9 and 11).

The housing-side extending portion 72 is a portion of the conductive member 70 that extends from the first end portion 71a of the winding portion 71 toward the motor housing 62 to be pressed against the motor housing 62.

In the initial state of the conductive member 70, the housing-side extending portion 72 extends from the first end portion 71a of the winding portion 71 toward the -V3 direction, as viewed from the V2 direction (in front view of FIG. 11). In the initial state of the conductive member 70, the housing-side extending portion 72 extends in an L-shape as viewed from the V1 direction (in side view of FIG. 12). Specifically, in the initial state of the conductive member 70, as viewed from the V1 direction (in side view of FIG. 12), the housing-side extending portion 72 includes: a portion 72a extending from the first end portion 71a of the winding portion 71 toward the +V2 direction and the -V3 direction; and a portion 72c extending toward the -V2 direction and the -V3 direction after being curved from the portion 72a (via a curved portion 72b). In the initial state of the conductive member 70, as viewed from the V3 direction (in plan view of FIG. 13), the housing-side extending portion 72 extends toward the +V2 direction from the first end portion 71a of the winding portion 71, and then curves and extends so as to overlap this portion (along the V2 direction).

In the assembled state of the conductive member 70, the housing-side extending portion 72 is held in contact with the outer peripheral surface of the motor housing 62. In the at least one embodiment, in the assembled state of the conductive member 70, the portion 72a, which is closer to the first end portion 71a of the winding portion 71 with respect to the curved portion 72b, of the housing-side extending portion 72 is held in contact with a front upper surface of the motor housing 62 (see FIGS. 7 and 12).

The ground-side extending portion 73 is a portion of the conductive member 70 that extends from the second end portion 71b of the winding portion 71 toward the ground portion 82 to be pressed against the ground portion 82.

In the initial state of the conductive member 70, the ground-side extending portion 73 extends in a crank shape, as viewed from the V2 direction (in front view of FIG. 11). Specifically, in the initial state of the conductive member 70, as viewed from the V2 direction (in front view of FIG. 11), the ground-side extending portion 73 includes: a portion 73a extending from the second end portion 71b of the winding portion 71 toward the -V3 direction; a portion 73c extending toward the -V1 direction after being curved from the portion 73a (via a curved portion 73b); a portion 73e extending toward the -V3 direction after being curved from the portion 73c (via a curved portion 73d); and a portion 73g extending toward the +V1 direction after being curved from the portion 73e (via a curved portion 73f). In the initial state of the conductive member 70, as viewed from the V1 direction (in side view of FIG. 12), the ground-side extending portion 73 extends toward the -V3 direction from the second end portion 71b of the winding portion 71, and then curves and extends so as to overlap this portion (along the V3 direction). In the initial state of the conductive member 70, as viewed from the V3 direction (in plan view of FIG. 13), the ground-side extending portion 73 extends toward the -V1 direction from the second end portion 71b of the winding portion 71, and then curves and extends so as to overlap this portion (along the V1 direction).

In the assembled state of the conductive member 70 and the mounted state of the control board 80, the ground-side extending portion 73 is held in contact with the ground portion 82. In the at least one embodiment, in the assembled state of the conductive member 70 and the mounted state of the control board 80, the portion 73g (portion between the curved portion 73f on the -V1 side and a curved portion 73h on the +V1 side) extending in the V1 direction on the -V3 end side in the ground-side extending portion 73 is held in contact with the ground portion 82 (see FIGS. 7, 9 and 11).

The stopper-side extending portion 74 is a portion of the conductive member 70 that extends from the ground-side extending portion 73 toward the stopper 92b to be pressed against the stopper 92b.

In the initial state of the conductive member 70, the stopper-side extending portion 74 extends in an L-shape as viewed from the V2 direction (in front view of FIG. 11). Specifically, in the initial state of the conductive member 70, as viewed from the V2 direction (in front view of FIG. 11), the stopper-side extending portion 74 includes: a portion 74a extending toward the +V1 direction and the +V3 direction via the curved portion 73h from the +V1 end portion of the portion 73g extending in the V1 direction on the -V3 end side in the ground-side extending portion 73; and a portion 74c extending toward the -V1 direction and the +V3 direction after being curved from the portion 74a (via a curved portion 74b). In the initial state of the conductive member 70, the stopper-side extending portion 74 curves and extends so as to overlap a part of the ground-side extending portion 73 (along the V3 direction) as viewed from the V1 direction (in side view of FIG. 12). In the initial state of the conductive member 70, the stopper-side extending portion 74 curves and extends so as to overlap a part of the ground-side extending portion 73 (along the V1 direction) as viewed from the V3 direction (in plan view of FIG. 13).

In the assembled state of the conductive member 70, the stopper-side extending portion 74 is held in contact with the stopper 92b. In the at least one embodiment, in the assembled state of the conductive member 70, the portion 74a, which is on the ground-side extending portion 73 side with respect to the curved portion 74b, of the stopper-side extending portion 74 is held in contact with a portion on the -X direction side of the stopper 92b (see FIGS. 9 and 11).

### Method of Assembling Conductive Member

Next, an example of a method of assembling the conductive member 70 is described.

The conductive member 70 is detachably assembled to a part of the thermal printer 10. Specifically, a part (portion on the -V3 end side of the ground-side extending portion 73) of the conductive member 70 is inserted into the space 92s of the first side wall portion 92 from the +X direction to be caused to pass through the space 92s (first procedure). Next, after inserting a part of the head shaft 50 into the winding portion 71 of the conductive member 70, the head shaft 50 is fixed to the frame 90 (second procedure). The above-mentioned first procedure and second procedure may be performed in reverse.

Next, an upper end portion of the control board 80 is sandwiched between the locking portion 92a of the first side wall portion 92 and a part (portion on the -V3 end side) of the conductive member 70 so that the control board 80 is mounted.

As a result, the conductive member 70 can be assembled at a predetermined position in the thermal printer 10.

### Contact State of Conductive Member

Next, a contact state of the conductive member 70 is described. In the assembled state of the conductive member 70, a part (portion on the -V3 end side) of the conductive member 70 has a clip shape. In the assembled state of the conductive member 70, a part (stopper-side extending portion 74) of the clip-shaped portion of the conductive member 70 is brought into contact with the stopper 92b so that a spring force acts in the horizontal direction (V1 direction). Under this state, an outer shape of a part (stopper-side extending portion 74) of the conductive member 70 is displaced in the direction of the arrow D1 in FIG. 11 so that a spring force (restoring force) acts on the conductive member 70. Due to this restoring force, the winding portion 71 is displaced in the direction of the arrow F1 in FIG. 9 to be brought into contact with the connection arm 42 on the first side wall portion 92 side.

In the assembled state of the conductive member 70, a part (portion on the -V3 end side with respect to the winding portion 71) of the conductive member 70 is sandwiched between the stopper 92b and the motor housing 62 so that a spring force acts in the front-rear direction (V2 direction). Under this state, an outer shape of a part (housing-side extending portion 72) of the conductive member 70 is displaced in the direction of the arrow D2 in FIG. 12 so that a spring force (restoring force) acts on the conductive member 70. Due to this restoring force, the housing-side extending portion 72 is brought into contact with the motor housing 62 (see FIG. 7). Further, due to the restoring force of the conductive member 70, the winding portion 71 is displaced in a predetermined direction to be brought into contact with the head shaft 50 (see FIG. 7).

In the assembled state of the conductive member 70 and the mounted state of the control board 80, a part (ground-side extending portion 73) of the conductive member 70 is sandwiched between the stopper 92b and the motor housing 62 via the control board 80 (ground portion 82). A spring force (spring force larger than in the state in FIG. 4) acts in the front-rear direction (V2 direction) on this sandwiched portion. Under this state, an outer shape of a part (ground-side extending portion 73) of the conductive member 70 is displaced in a direction opposite to the direction of the arrow D2 in FIG. 12 so that a spring force (restoring force) acts on the conductive member 70. Due to this restoring force, the ground-side extending portion 73 is brought into contact with the ground portion 82 of the control board 80 (see FIGS. 7 and 9).

As a result, the conductive member 70 can also be brought into contact with and electrically connected to the ground portion 82 of the control board 80 by a simple method without using screws or the like.

### Operation Method of Portable Terminal 1

Next, an example of an operation method of the portable terminal 1 is described. In the following description, it is assumed that a leading edge of the recording paper P is nipped between the platen roller 30 and the thermal head 20.

In the portable terminal 1, printing on the recording paper P is started through operation of the operation unit 12. Specifically, a signal is output from the control board 80 to the motor 60 through, for example, the wiring 83, with the result that the motor 60 rotates. After the power of the motor 60 is reduced in speed via the power transmission mechanism 100, the power is transmitted to the driven gear 35. The platen roller 30 rotates due to the rotation of the driven gear 35. The recording paper P nipped between the outer peripheral surface of the platen roller 30 and the thermal head 20 is delivered toward the delivery port 18 due to the rotation of the platen roller 30.

When the signal is output from the control board 80 to the thermal head 20 through the flexible substrate 84 during the course of delivering the recording paper P due to the rotation of the platen roller 30, the thermal head 20 (heating elements) generate heat. With this heat generation, various information is printed on the recording paper P. Then, the recording paper P having the various information printed thereon and delivered through the delivery port 18 is cut and used as, for example, a receipt.

### Effects

The thermal printer 10 according to the at least one embodiment includes: the thermal head 20 that performs printing on the recording paper P; the platen roller 30, which is arranged at a position opposed to the thermal head 20, and conveys the recording paper P by nipping the recording paper P between the platen roller 30 and the thermal head 20; the head support member 40 having conductivity, which supports the thermal head 20; the head shaft 50 having conductivity, which rotatably supports the head support member 40; the motor housing 62 having conductivity, which is provided on the outer periphery of the motor main body 61 that rotates the platen roller 30; and the conductive member 70 that is held in contact with the head support member 40, the head shaft 50, and the motor housing 62 to provide electrical connection therebetween.

According to this configuration, with the provision of the conductive member 70 that is held in contact with the head support member 40, the head shaft 50, and the motor housing 62 to provide electrical connection therebetween, the head support member 40, the head shaft 50, and the motor housing 62 can be set to have the same potential. As a result, malfunctions due to static electricity can be suppressed. In addition, it is not required to provide a ground wire for each component in order to electrically connect the head support member 40, the head shaft 50, and the motor housing 62. As a result, securing a space is not required, and an increase in assembly work and an increase in the number of components can be suppressed. Accordingly, malfunctions due to static electricity can be suppressed, securing a space is not required, and an increase in assembly work and an increase in the number of components can be suppressed.

The conductive member 70 in the at least one embodiment is held in elastic contact with the head support member 40, the head shaft 50, and the motor housing 62.

According to this configuration, due to the elasticity of the conductive member 70, the head support member 40, the head shaft 50, and the motor housing 62 can be set to have the same potential. Accordingly, it is not required to provide a separate member for connection in order to electrically connect the head support member 40, the head shaft 50, and the motor housing 62. As a result, securing a space is not required, and an increase in assembly work and an increase in the number of components can be more effectively suppressed.

The thermal printer 10 according to the at least one embodiment further includes the control board 80 including the ground portion 82. The conductive member 70 is held in elastic contact with the head support member 40, the head shaft 50, the motor housing 62, and the ground portion 82.

According to this configuration, due to the elasticity of the conductive member 70, the head support member 40, the head shaft 50, the motor housing 62, and the ground portion 82 can be set to have the same potential. Accordingly, it is not required to provide a separate member for connection in order to electrically connect the head support member 40, the head shaft 50, the motor housing 62, and the ground portion 82. As a result, securing a space is not required, and an increase in assembly work and an increase in the number of components can be more effectively suppressed.

The head support member 40 in the at least one embodiment includes: the head support plate 41 that supports the thermal head 20; and the connection arms 42 and 43 connected to the head support plate 41 and rotatably supported on the head shaft 50. The conductive member 70 includes the winding portion 71 that is wound around the head shaft 50 to be pressed against the connection arm 42 and the head shaft 50.

According to this configuration, with the winding portion 71 of the conductive member 70 being pressed against the connection arm 42 and the head shaft 50, it is not required to provide a separate member for connection in order to electrically connect the connection arm 42 and the head shaft 50. Accordingly, securing a space is not required, and an increase in assembly work and an increase in the number of components can be more effectively suppressed. In addition, with the winding portion 71 of the conductive member 70 being positioned with respect to the connection arm 42 and the head shaft 50, it is not required to provide a separate member for positioning. As a result, the conductive member 70 can be more easily assembled.

The conductive member 70 in the at least one embodiment includes the housing-side extending portion 72 extending from the first end portion of the winding portion 71 toward the motor housing 62 to be pressed against the motor housing 62.

According to this configuration, with the housing-side extending portion 72 of the conductive member 70 being pressed against the motor housing 62, it is not required to provide a separate member for connection in order to electrically connect the head shaft 50 and the motor housing 62. Accordingly, securing a space is not required, and an increase in assembly work and an increase in the number of components can be more effectively suppressed. In addition, with the housing-side extending portion 72 of the conductive member 70 being positioned with respect to the motor housing 62, it is not required to provide a separate member for positioning. Accordingly, the conductive member 70 can be more easily assembled.

The conductive member 70 in the at least one embodiment includes the ground-side extending portion 73 extending from the second end portion of the winding portion 71 toward the ground portion 82 to be pressed against the ground portion 82.

According to this configuration, with the ground-side extending portion 73 of the conductive member 70 being pressed against the ground portion 82 of the control board 80, it is not required to provide a separate member for connection in order to electrically connect the head shaft 50 and the ground portion 82. Accordingly, securing a space is not required, and an increase in assembly work and an increase in the number of components can be more effectively suppressed. In addition, with the ground-side extending portion 73 of the conductive member 70 being positioned with respect to the ground portion 82 of the control board 80, it is not required to provide a separate member for positioning. Accordingly, the conductive member 70 can be more easily assembled.

The thermal printer 10 according to the at least one embodiment further includes the frame 90 including the stopper 92b. The conductive member 70 includes the stopper-side extending portion 74 extending from the ground-side extending portion 73 toward the stopper 92b to be pressed against the stopper 92b.

According to this configuration, with the stopper-side extending portion 74 of the conductive member 70 being positioned with respect to the stopper 92b of the frame 90 by being pressed against the stopper 92b, it is not required to provide a separate member for positioning. Accordingly, the conductive member 70 can be more easily assembled.

The winding portion 71, the housing-side extending portion 72, the ground-side extending portion 73, and the stopper-side extending portion 74 in the at least one embodiment are integrally formed from the same member.

According to this configuration, electrical connection of the connection arms 42 and 43, the head shaft 50, the motor housing 62, and the ground portion 82 can be achieved by the conductive member 70 (only one component). Accordingly, securing a space is not required, and an increase in assembly work and an increase in the number of components can be more effectively suppressed.

The portable terminal 1 according to the at least one embodiment includes the thermal printer 10 described above.

According to this configuration, the portable terminal 1 that enables suppressing malfunctions due to static electricity and suppressing an increase in assembly work and an increase in the number of components, without requiring securing a space can be obtained.

The portable terminal 1 according to the at least one embodiment further includes: the control board 80 including the ground portion 82; and the casing 11 including the bottom surface portion 11a, and the delivery surface portion 11b provided to stand upright from the bottom surface portion 11a, and having the delivery port 18 through which the recording paper P is allowed to be delivered to the outside. The control board 80 is provided so as to extend along the delivery surface portion 11b. The ground portion 82 is provided at the end portion of the control board 80 on the side opposite to the bottom surface portion 11a.

According to this configuration, a connection path to the ground portion 82 in the conductive member 70 can be shortened as compared with a case in which the ground portion 82 is provided at an end portion of the control board 80 on the same side as the bottom surface portion 11a. Accordingly, securing a space is not required, and an increase in assembly work and an increase in the number of components can be more effectively suppressed. In addition, a degree of freedom in component layout on the bottom surface portion 11a side can be improved as compared with a case in which the control board 80 is provided so as to extend along the bottom surface portion 11a. For example, a cover (component such as a bottom lid) for covering the control board on the bottom surface portion side can be eliminated.

### Modification Example

Note that, the technical scope of the present invention is not limited to the above-mentioned embodiment, but various modifications may be made without departing from the gist of the present invention.

In the at least one embodiment described above, description has been given of the example in which the conductive member is held in elastic contact with the head support member, the head shaft, and the motor housing, but the configuration is not limited thereto. For example, a separate member for connection may be provided in order to electrically connect the head support member, the head shaft, and the motor housing. The mode for electrically connecting the head support member, the head shaft, and the motor housing can be changed according to design specifications.

In the at least one embodiment described above, description has been given of the example in which the thermal printer further includes the control board including the ground portion, and the conductive member is held in elastic contact with the head support member, the head shaft, the motor housing, and the ground portion. However, the configuration is not limited thereto. For example, a separate member for connection may be provided in order to electrically connect the head support member, the head shaft, the motor housing, and the ground portion. The mode for electrically connecting the head support member, the head shaft, the motor housing, and the ground portion can be changed according to design specifications.

In the at least one embodiment described above, description has been given of the example in which the head support member includes the head support plate that supports the thermal head, and the connection arms connected to the head support plate, and rotatably supported on the head shaft, and the conductive member includes the winding portion that is wound around the head shaft to be pressed against the connection arm and the head shaft. However, the configuration is not limited thereto. For example, a separate member for connection may be provided in order to electrically connect the connection arm and the head shaft. The mode for electrically connecting the connection arm and the head shaft can be changed according to design specifications.

In the at least one embodiment described above, description has been given of the example in which the conductive member includes the housing-side extending portion extending from the first end portion of the winding portion toward the motor housing to be pressed against the motor housing. However, the configuration is not limited thereto. For example, a separate member for connection may be provided in order to electrically connect the head shaft and the motor housing. The mode for electrically connecting the head shaft and the motor housing can be changed according to design specifications.

In the at least one embodiment described above, description has been given of the example in which the conductive member includes the ground-side extending portion extending from the second end portion of the winding portion toward the ground portion to be pressed against the ground portion. However, the configuration is not limited thereto. For example, a separate member for connection may be provided in order to electrically connect the head shaft and the ground portion. The mode for electrically connecting the head shaft and the ground portion can be changed according to design specifications.

In the at least one embodiment described above, description has been given of the example in which the thermal printer further includes the frame including the stopper, and the conductive member includes the stopper-side extending portion extending from the ground-side extending portion toward the stopper to be pressed against the stopper. However, the configuration is not limited thereto. For example, a separate member for positioning may be provided in order to position the conductive member with respect to the stopper. The mode for positioning the conductive member can be changed according to design specifications.

In the at least one embodiment described above, description has been given of the example in which the winding portion, the housing-side extending portion, the ground-side extending portion, and the stopper-side extending portion are integrally formed from the same member, but the configuration is not limited thereto. For example, the winding portion, the housing-side extending portion, the ground-side extending portion, and the stopper-side extending portion may be formed by combining a plurality of members. The mode for forming the winding portion, the housing-side extending portion, the ground-side extending portion, and the stopper-side extending portion can be changed according to design specifications.

In the at least one embodiment described above, description has been given of the example of the portable terminal including the thermal printer, but the configuration is not limited thereto. For example, the thermal printer may be applied to various devices other than the portable terminal. An application target of the thermal printer can be changed according to design specifications.

In the at least one embodiment described above, description has been given of the example in which the portable terminal further includes the control board including the ground portion, and the casing including the bottom surface portion, and the delivery surface portion provided to stand upright from the bottom surface portion and having the delivery port through which the recording paper is allowed to be delivered to the outside; the control board is provided so as to extend along the delivery surface portion; and the ground portion is provided at the end portion of the control board on the side opposite to the bottom surface portion. However, the configuration is not limited thereto. For example, the ground portion may be provided at the end portion of the control board on the same side as the bottom surface portion. For example, the control board may be provided so as to extend along the bottom surface portion. The arrangement mode of the ground portion and/or the arrangement mode of the control board can be changed according to design specifications.

The foregoing description is illustrative and not restrictive. The scope of the invention is defined by the appended claims.

What is claimed is:

1. A thermal printer, comprising:
a thermal head configured to perform printing on recording paper;
a platen roller, which is arranged at a position opposed to the thermal head, and is configured to convey the recording paper by nipping the recording paper between the platen roller and the thermal head;
a head support member having conductivity, which is configured to support the thermal head;
a head shaft having conductivity, which is configured to rotatably support the head support member;
a motor housing having conductivity, which is provided on an outer periphery of a motor main body configured to rotate the platen roller; and
a conductive member configured to be held in contact with the head support member, the head shaft, and the motor housing to provide electrical connection therebetween.

2. The thermal printer according to claim 1, wherein the conductive member is configured to be held in elastic contact with the head support member, the head shaft, and the motor housing.

3. The thermal printer according to claim 2, further comprising a control board including a ground portion,
wherein the conductive member is configured to be held in elastic contact with the head support member, the head shaft, the motor housing, and the ground portion.

4. The thermal printer according to claim 3,
wherein the head support member includes:
a head support plate configured to support the thermal head; and
a connection arm configured to be connected to the head support plate, and to be rotatably supported on the head shaft, and
wherein the conductive member includes a winding portion configured to be wound around the head shaft to be pressed against the connection arm and the head shaft.

5. The thermal printer according to claim 4, wherein the conductive member includes a housing-side extending portion extending from a first end portion of the winding portion toward the motor housing to be pressed against the motor housing.

6. The thermal printer according to claim 5, wherein the conductive member includes a ground-side extending portion extending from a second end portion of the winding portion toward the ground portion to be pressed against the ground portion.

7. The thermal printer according to claim 6, further comprising a frame including a stopper,
wherein the conductive member includes a stopper-side extending portion extending from the ground-side extending portion toward the stopper to be pressed against the stopper.

8. The thermal printer according to claim 7, wherein the winding portion, the housing-side extending portion, the ground-side extending portion, and the stopper-side extending portion are integrally formed from the same member.

9. A portable terminal, comprising the thermal printer according to claim 1.

10. The portable terminal according to claim 9, further comprising:
a control board including a ground portion; and
a casing including:
a bottom surface portion; and
a delivery surface portion, which is provided to stand upright from the bottom surface portion, and has a delivery port through which the recording paper is allowed to be delivered to an outside,
wherein the control board is provided so as to extend along the delivery surface portion, and
wherein the ground portion is provided at an end portion of the control board on a side opposite to the bottom surface portion.
